(19) United States
(12) Patent Application Publication
(10) Pub. No.: US 2026/0208561 A1
(43) Pub. Date: Jul. 23, 2026

(54) THERMAL CONDITIONING SYSTEM

(71) Applicant: Valeo Systemes Thermiques, Le Mesnil-Saint-Denis (FR)

(72) Inventors: Moussa Nacer-Bey, Le Mesnil-Saint-Denis (FR); Kamel Azzouz, Le Mesnil-Saint-Denis (FR); Julien Tissot, Le Mesnil-Saint-Denis (FR); Jeremy Blandin, Le Mesnil-Saint-Denis (FR); Marc Baronnier, Le Mesnil-Saint-Denis (FR); Sebastien Garnier, Le Mesnil-Saint-Denis (FR)

(73) Assignee: Valeo Systemes Thermiques, Le Mesnil-Saint-Denis (FR)

(21) Appl. No.: 19/134,896

(22) PCT Filed: Nov. 27, 2023
(86) PCT No.: PCT/EP2023/083130

§ 371 Date: Jun. 2, 2025

(30) Foreign Application Priority Data
Dec. 2, 2022 (FR) 2212721

(51) Int. Cl. B60H 1/32; B60H 1/00

(52) U.S. Cl. CPC B60H 1/32284; B60H 1/00392; B60H 1/00278; B60H 2001/00307; B60H 2001/3288

(57) ABSTRACT

Described is a thermal conditioning system for a vehicle. The thermal conditioning system includes a heat-transfer fluid circuit having a primary heat-transfer fluid circulation loop, a secondary heat-transfer fluid circulation loop, and a refrigerant fluid circuit with a main refrigerant fluid circulation loop. The main refrigerant fluid circulation loop includes a compression device, a first heat exchanger, an expansion valve, and a second heat exchanger. The primary heat-transfer fluid loop includes a third heat exchanger configured to exchange heat with an internal air flow, and the secondary heat-transfer fluid loop includes a fourth heat exchanger configured to be thermally coupled to a first element of an electric powertrain.

### TECHNICAL FIELD

The present invention relates to the field of thermal conditioning systems. These systems may in particular be provided on a motor vehicle. Such systems allow thermal regulation of various members of the vehicle, such as the passenger compartment or an electrical energy storage battery for example, in the case of an electrically powered vehicle. The heat exchanges are mainly managed by the compression and expansion of a refrigerant within various heat exchangers, allowing the heating or cooling of various members.

### PRIOR ART

Thermal conditioning systems often make use of a refrigerant loop and a loop for heat-transfer fluid that exchanges heat with the refrigerant. Such systems are thus referred to as indirect. The refrigerant loop is formed so that the refrigerant gives up heat to a heat-transfer fluid in a first two-fluid exchanger. The heat given up to the heat-transfer fluid can then be dissipated into an air stream intended for the passenger compartment, in order to heat it. The heat-transfer fluid circuit also makes it possible to cool elements of the drive train of the vehicle that dissipate heat, such as the electric drive motor of the vehicle or the power electronics controlling the electric motor. To this end, another two-fluid exchanger allows a heat exchange between the heat-transfer fluid and the refrigerant in order to cool the heat-transfer fluid.

In addition, the rapid charging requirements of the batteries require an increase in the cooling power available. In order for high cooling power to be available for cooling the batteries, together with satisfactory uniformity of the temperature of the batteries, it is known practice to circulate a dielectric heat-transfer fluid inside the elements of the battery. In this case, an additional two-fluid exchanger is used, in order to exchange heat between the refrigerant and the dielectric heat-transfer fluid. This configuration is complex and costly to implement as a large number of heat exchangers is used, in particular a large number of two-fluid heat exchangers.

There is therefore a need to provide thermal conditioning systems which are easier to incorporate and use fewer heat exchangers and simpler circuits for the circulation of the various fluids.

### SUMMARY

To this end, the present invention proposes a thermal conditioning system for a motor vehicle, comprising:
a heat-transfer fluid circuit, in particular for dielectric heat-transfer fluid, comprising:
a primary heat-transfer fluid circulation loop,
a secondary heat-transfer fluid circulation loop,
a refrigerant circuit comprising a main refrigerant circulation loop, the main loop comprising in succession, in a direction of circulation of the refrigerant:
a compression device,
a first heat exchanger, arranged both on the main refrigerant loop and on the primary heat-transfer fluid loop, so as to allow heat exchange between the refrigerant and the heat-transfer fluid,
an expansion device,
a second heat exchanger, arranged both on the main refrigerant loop and on the secondary heat-transfer fluid loop, so as to allow heat exchange between the refrigerant and the heat-transfer fluid,
   wherein:
the primary heat-transfer fluid loop comprises a third heat exchanger configured to exchange heat with an air stream inside a passenger compartment of the vehicle, and
the secondary heat-transfer fluid loop comprises a fourth heat exchanger configured to be thermally coupled to a first element of an electric drive train of the vehicle,
   wherein the heat-transfer fluid circuit comprises:
a first bypass branch connecting a first connection point, positioned on the primary loop between a first outlet of the first heat exchanger and a first inlet of the third heat exchanger, to a second connection point, positioned on the secondary loop between a first outlet of the second heat exchanger and a first inlet of the fourth heat exchanger,
a second bypass branch connecting a third connection point, positioned on the primary loop between a second inlet of the first heat exchanger and a second outlet of the third heat exchanger, to a fourth connection point, positioned on the secondary loop between a second inlet of the second heat exchanger and a second outlet of the fourth heat exchanger,
   and wherein:
the heat-transfer fluid circuit comprises a third bypass branch connecting a fifth connection point, positioned on the secondary loop between the second outlet of the fourth heat exchanger and the fourth connection point, to a sixth connection point, positioned on the secondary loop between the first outlet of the second heat exchanger and the first inlet of the fourth heat exchanger, the third bypass branch comprising a fifth heat exchanger configured to exchange heat with the air stream inside the passenger compartment of the vehicle.

The circuit for the heat-transfer fluid, in particular the dielectric heat-transfer fluid, thus comprises the functions of cooling and heating of the passenger compartment, thermal management of the batteries and/or power electronics, and—for certain operating modes—dehumidification.

According to one embodiment, the sixth connection point is positioned between the first outlet of the second heat exchanger and the second connection point.

According to another embodiment, the sixth connection point is positioned between the second connection point and the first inlet of the fourth heat exchanger.

The first element of the electric drive train of the vehicle may be an electrical energy storage battery. The battery can supply the energy necessary for an electric drive motor of the vehicle. The thermal coupling with the fourth heat exchanger may be achieved by means of a heat-transfer fluid circulation loop, not shown in the various figures. The thermal coupling may also be achieved by placing one or more walls of the fourth heat exchanger in contact with one or more walls of the battery.

According to one embodiment, the fourth heat exchanger may be formed by the battery itself, i.e. the battery dissipating heat is in direct contact with the heat-transfer fluid, when this is a dielectric heat-transfer fluid.

In particular, the electrical and/or electronic elements of the battery may be immersed, or partially immersed, in a dielectric heat-transfer fluid.

The total or partial immersion of the electrical and/or electronic elements of the battery allows an improvement in the thermal exchanges with the heat-transfer fluid, by eliminating thermal resistances, in particular contact resistances, between the fourth heat exchanger and said electrical and/or electronic elements.

According to one embodiment of the thermal conditioning system, the heat-transfer fluid circuit comprises a fourth bypass branch connecting a seventh connection point, positioned on the first bypass branch, to an eighth connection point, positioned on the second bypass branch, the fourth bypass branch comprising a sixth heat exchanger.

The sixth heat exchanger is configured to exchange heat with an air stream outside the passenger compartment of the motor vehicle.

The seventh connection point is positioned on the first bypass branch between the first connection point and the second connection point.

The eighth connection point is positioned on the second bypass branch between the third connection point and the fourth connection point.

According to one embodiment of the thermal conditioning system, the heat-transfer fluid circuit comprises a fifth bypass branch, positioned on the secondary loop in parallel with the fourth heat exchanger, connecting a ninth connection point positioned on the secondary loop to a tenth connection point positioned on the secondary loop, the fifth bypass branch comprising a seventh heat exchanger configured to be thermally coupled to a second element of the electric drive train of the vehicle.

The ninth connection point is positioned on the secondary loop between the second connection point and the first inlet of the fourth heat exchanger.

The tenth connection point is positioned on the secondary loop between the second outlet of the fourth heat exchanger and the fifth connection point.

The role of the seventh heat exchanger is to thermally regulate the second element of the electric drive train of the vehicle.

The second element of the electric drive train of the vehicle may for example be an electronic control unit of an electric drive motor and/or an electric drive motor of the vehicle.

The seventh heat exchanger may be formed by the actual electronic control unit of the electric motor and/or by the electric motor itself, i.e. the electronic control unit of the electric motor and/or the electric motor dissipating heat are in direct contact with the heat-transfer fluid, when this is a dielectric heat-transfer fluid.

In particular, the electrical and/or electronic elements of the electronic control unit of the electric motor and/or of the electric motor itself may be immersed, or partially immersed, in a dielectric heat-transfer fluid.

The total or partial immersion of the electrical and/or electronic elements of the electronic control unit of the electric motor and/or of the electric motor itself allows an improvement in the thermal exchanges with the heat-transfer fluid by eliminating thermal resistances, in particular contact resistances, between the seventh heat exchanger and said electrical and/or electronic elements.

According to one embodiment of the thermal conditioning system, the primary loop of the heat-transfer fluid circuit comprises a first circulation pump.

The first pump is configured to cause circulation of the heat-transfer fluid from the third connection point towards the second inlet of the first heat exchanger.

According to one exemplary embodiment, the first pump is positioned between the third connection point and the second inlet of the first heat exchanger.

According to another exemplary embodiment, the first pump is positioned between the first outlet of the first heat exchanger and the first connection point.

According to one embodiment of the thermal conditioning system, the secondary loop of the heat-transfer fluid circuit comprises a second circulation pump.

The second pump is configured to cause circulation of the heat-transfer fluid from the ninth connection point towards the first inlet of the fourth heat exchanger.

According to one exemplary embodiment, the second pump is positioned between the ninth connection point and the first inlet of the fourth heat exchanger.

According to another exemplary embodiment, the second pump is positioned between the second outlet of the fourth heat exchanger and the tenth connection point.

According to one embodiment of the thermal conditioning system, the heat-transfer fluid circuit comprises a first three-way valve positioned both on the first bypass branch and on the fourth bypass branch.

The first three-way valve is configured to selectively:
permit a circulation of heat-transfer fluid in the first bypass branch, and prohibit a circulation of heat-transfer fluid between the first bypass branch and the sixth heat exchanger, or
permit a circulation of heat-transfer fluid between the first bypass branch and the sixth heat exchanger, and prohibit a circulation of heat-transfer fluid between the first bypass branch and the primary heat-transfer fluid loop, or
permit a circulation of heat-transfer fluid between the primary loop and the sixth heat exchanger, and prohibit a circulation of heat-transfer fluid between the secondary loop and the first bypass branch.

According to one embodiment of the thermal conditioning system, the heat-transfer fluid circuit comprises a second three-way valve positioned both on the second bypass branch and on the fourth bypass branch.

The second three-way valve is configured to selectively:
permit a circulation of heat-transfer fluid in the second bypass branch, and prohibit a circulation of heat-transfer fluid between the second bypass branch and the sixth heat exchanger, or
permit a circulation of heat-transfer fluid between the secondary bypass branch and the sixth heat exchanger, and prohibit a circulation of heat-transfer fluid between the second bypass branch and the primary heat-transfer fluid loop, or
permit a circulation of heat-transfer fluid between the primary loop and the sixth heat exchanger, and prohibit a circulation of heat-transfer fluid between the secondary loop and the second bypass branch.

According to one embodiment of the thermal conditioning system, the third bypass branch comprises a shut-off valve.

The shut-off valve is arranged between the fifth connection point and the sixth connection point.

According to one exemplary embodiment, the shut-off valve is positioned between the sixth connection point and the fifth heat exchanger.

According to another exemplary embodiment, the shut-off valve is arranged between the fifth heat exchanger and the fifth connection point.

The shut-off valve is a two-way valve.

According to one embodiment, the secondary loop of the heat-transfer fluid circuit comprises a third circulation pump.

The third pump is configured to cause circulation of the heat-transfer fluid from the fourth connection point towards the second inlet of the second heat exchanger.

According to one exemplary embodiment, the third pump is positioned between the fourth connection point and the second inlet of the second heat exchanger.

According to another exemplary embodiment, the third pump is positioned between the first outlet of the second heat exchanger and the sixth connection point.

According to one embodiment of the thermal conditioning system, at least the primary loop and/or the secondary loop comprises at least one filtering device, in particular at the outlet of the at least one of the pumps and/or of the at least one of the heat exchangers.

The filtering devices positioned on the at least one of the primary and/or secondary loops allow capture of debris, in particular metallic debris, in particular coming from the pumps and/or the heat exchangers.

The debris is liable to become detached during operation.

In particular, in the case of use of a heat-transfer fluid of the dielectric heat-transfer fluid type, and more particularly in the case where the fourth heat exchanger and/or the seventh heat exchanger are formed respectively by the battery and the actual electronic control unit of the electric motor and/or by the electric motor itself, the filtering devices allow protection of the first and/or second elements of the electric drive train of the vehicle.

Preferably, the filtering devices are positioned downstream of the first, second, third, fifth and/or sixth heat exchangers and/or of the pumps, and/or upstream of the fourth and/or seventh heat exchangers.

Upstream and downstream are defined relative to the direction of circulation of the heat-transfer fluid.

In particular, in the case where the fourth heat exchanger and the seventh heat exchanger are formed respectively by the battery and the actual electronic control unit of the electric motor and/or by the electric motor itself, the filtering devices are preferably positioned in the battery and in the actual electronic control unit of the electric motor and/or in the electric motor itself, preferably at the inlet.

According to one embodiment of the thermal conditioning system, in which the heat-transfer fluid of the heat-transfer fluid circuit is a dielectric heat-transfer fluid, at least one of the pumps and/or at least one of the three-way valves and/or the shut-off valve and/or the expansion device comprises a bypass circuit, connecting the heat-transfer fluid circuit to the electronic power and control part of said at least one pump and/or a three-way valve and/or the shut-off valve and/or the expansion device.

The bypass circuit is a take-off branch fluidically connecting the heat-transfer fluid circuit to the electronic power and control part of at least one component of the thermal conditioning system.

The term “components of the thermal system” here means the pumps, the three-way valves, the shut-off valve and the expansion device.

Said take-off branch is arranged as close as possible to said component.

By means of the bypass circuit, cooling of the electronic power and control part of the at least one pump and/or a three-way valve and/or the shut-off valve and/or the expansion device can be ensured.

The cooling of the electronic power and control part of the at least one pump and/or a three-way valve and/or the shut-off valve and/or the expansion device is achieved by circulation of the dielectric heat-transfer fluid in the compartment of the electronic power and control part.

According to one embodiment of the thermal conditioning system, in which the heat-transfer fluid of the heat-transfer fluid circuit is a dielectric heat-transfer fluid, at least one of the heat exchangers comprises a desiccator.

The desiccator is preferably positioned in the header tank of at least one of the heat exchangers.

Desiccators enable moisture to be captured and can hence avoid the formation of mold.

Desiccators can in particular take the form of receptacles containing silica gel, in particular in the form of crystals, or active charcoal, calcium sulphate, calcium chloride, or molecular sieves, in particular zeolites.

In particular, in the case where the fourth heat exchanger and the seventh heat exchanger are formed respectively by the battery and the actual electronic control unit of the electric motor and/or by the electric motor itself, the desiccators enable the removal of all traces of humidity from the dielectric heat-transfer fluid, and can hence avoid deterioration in its dielectric properties. Said desiccators are then preferably positioned in the battery and in the actual electronic control unit of the electric motor and/or in the electric motor.

According to one embodiment of the thermal conditioning system, in which the heat-transfer fluid of the heat-transfer fluid circuit is a dielectric heat-transfer fluid, at least the secondary loop and/or the fifth bypass branch of the heat-transfer fluid circuit comprises at least one sensor configured to measure at least one parameter linked to the dielectric heat-transfer fluid, such as the electrical resistivity and/or the water content.

The at least one sensor allows continuous monitoring of the electrical properties and the water content of the dielectric heat-transfer fluid.

In particular, the positioning of at least one sensor on at least the secondary loop and/or the fifth bypass branch of the heat-transfer fluid circuit, more particularly upstream of the fourth heat exchanger and/or the seventh heat exchanger, allows protection of the first and/or second elements of the electric drive train of the vehicle.

In particular, in the case where the fourth heat exchanger and the seventh heat exchanger are respectively formed by the battery and/or the actual electronic control unit of the electric motor and/or by the electric motor itself, the sensors positioned upstream of the fourth and seventh heat exchangers make it possible to ensure that the electrical resistivity and water content in particular do not exceed certain values, and thus ensure the safety of the first and/or second elements of the electric drive train of the vehicle. Upstream is defined relative to the direction of circulation of the dielectric heat-transfer fluid.

In particular, in the case where the value of the electrical resistivity and/or water content exceeds a critical value, the circulation of the dielectric heat-transfer fluid could for example be interrupted by stopping the pumps.

According to one embodiment of the thermal conditioning system, in which the heat-transfer fluid of the heat-transfer fluid circuit is a dielectric heat-transfer fluid, the heat-transfer fluid circuit comprises at least one electrostatic discharge device configured to discharge the electrostatic charge from the dielectric heat-transfer fluid.

The at least one electrostatic discharge device allows discharge from the heat-transfer fluid of the electrostatic charge it has accumulated, for example by friction with the channels, in particular made of plastic.

According to a particular embodiment, the electrostatic discharge device is formed by a metallic contact between a metallic part of at least one of the heat exchangers and the structure of the vehicle.

In particular, in the case where the fourth heat exchanger and/or the seventh heat exchanger are formed respectively by the battery and/or the actual electronic control unit of the electric motor and/or by the electric motor, the electrostatic discharge devices allow protection of the first and/or second elements of the electric drive train of the vehicle.

According to one embodiment of the thermal conditioning system, at least one of the heat exchangers is liable to be obtained by a vacuum soldering process.

The vacuum soldering process of the at least one of the heat exchangers allows protection of the heat-transfer fluid and the refrigerant, and the heat exchangers, pumps, three-way valves, shut-off valve, expansion device, compressor, elements of the drive train, from contamination by soldering flux, in particular in the case of use of a heat-transfer fluid of the dielectric heat-transfer fluid type.

According to one embodiment of the thermal conditioning system, the thermal conditioning system comprises a dielectric fluid circuit comprising an additional loop for circulation of dielectric fluid, the additional loop comprising in succession, in a direction of circulation of the dielectric fluid:
an eighth heat exchanger configured to be thermally coupled to a first element of an electric drive train of the vehicle,
a fourth pump,
the seventh heat exchanger, arranged both on the secondary heat-transfer fluid loop and on the additional dielectric fluid loop, so as to allow heat exchange between the heat-transfer fluid and the dielectric fluid.

The role of the eighth heat exchanger is to thermally regulate the third element of the electric drive train of the vehicle.

The third element of the electric drive train of the vehicle may be an electric drive motor of the vehicle.

The eighth heat exchanger may be formed by the electric motor itself, i.e. the electric motor dissipating heat is in direct contact with the dielectric heat transfer fluid.

In particular, the electrical and/or electronic elements of the electric motor may be immersed, or partially immersed, in a dielectric fluid.

The total or partial immersion of the electrical and/or electronic elements of the electric motor allows an improvement in the thermal exchanges with the heat-transfer fluid by eliminating thermal resistances, in particular contact resistances, between the eighth heat exchanger and said electrical and/or electronic elements.

The dielectric fluid is a fluid with high viscosity and/or density, in particular higher than the viscosity and/or density of the heat-transfer fluid.

The dielectric fluid is in particular a fluid suitable for lubrication of the motor.

The dielectric fluid is in particular of the dielectric fluid or oil type.

According to one embodiment, the additional loop of the dielectric fluid circuit comprises at least one filtering device, in particular at the outlet of the fourth pump and/or at the inlet of the eighth heat exchanger.

In the case where the eighth heat exchanger is formed by the electric motor itself, the filtering device is preferably arranged in the electric motor itself, preferably at the inlet.

According to one embodiment, at least the fourth pump comprises a bypass circuit connecting the dielectric fluid circuit to the electronic power and control part of said at least fourth pump.

According to an embodiment, at least the eighth heat exchanger comprises a desiccator.

The desiccator is preferably positioned in the header tank of the eighth heat exchanger.

In the case where the eighth heat exchanger is formed by the electric motor itself, the desiccator is preferably arranged in the electric motor.

According to one embodiment, the additional loop of the dielectric fluid circuit comprises at least one sensor configured to measure at least one parameter linked to the dielectric fluid, such as the electrical resistivity and/or the water content.

In particular, the positioning of at least one sensor on the additional loop of the dielectric fluid circuit, more particularly upstream of the eighth heat exchanger, allows protection of the third element of the electric drive train of the vehicle.

According to one embodiment of the thermal conditioning system, the dielectric fluid circuit comprises at least one electrostatic discharge device configured to discharge the electrostatic charge from the dielectric fluid.

According to a particular embodiment, the electrostatic discharge device is formed by a metallic contact between a metallic part of the eighth heat exchanger and the structure of the vehicle.

According to one embodiment of the thermal conditioning system, the heat-transfer fluid circuit comprises a fifth circulation pump positioned on the fifth bypass branch.

The fifth pump is configured to cause circulation of the heat-transfer fluid from the ninth connection point towards the seventh heat exchanger.

According to one exemplary embodiment, the fifth pump is positioned between the ninth connection point and the seventh heat exchanger.

According to another exemplary embodiment, the fifth pump is positioned between the seventh heat exchanger and the tenth connection point.

According to a particular embodiment of the thermal conditioning system, the heat-transfer fluid circuit comprises a third three-way valve positioned both on the secondary loop and on the fifth bypass branch.

The third three-way valve is configured to selectively:
prohibit a circulation of heat-transfer fluid in the portion of the secondary loop comprising the fourth heat exchanger, and permit a circulation of heat-transfer fluid between the rest of the secondary loop and the fifth bypass branch, or
permit a circulation of heat-transfer fluid between the portion of the secondary loop comprising the fourth heat exchanger and the fifth bypass branch, and prohibit a circulation of heat-transfer fluid in the rest of the secondary loop, or
permit a circulation of heat-transfer fluid between the secondary loop and the fifth bypass branch.

According to a particular embodiment of the thermal conditioning system, the heat transfer fluid circuit comprises a fourth three-way valve positioned both on the secondary loop and on the first bypass branch.

The fourth three-way valve is configured to selectively:
prohibit a circulation of heat-transfer fluid in the portion of the secondary loop comprising the second heat exchanger, and permit a circulation of heat-transfer fluid between the rest of the secondary loop and the first bypass branch, or
permit a circulation of heat-transfer fluid between the secondary loop and the first bypass branch.

The invention also relates to a method of operation of a thermal conditioning system as described above, in a so-called drive train and passenger compartment cooling mode, in which:
a refrigerant flow circulates in the compressor where it becomes high-pressure refrigerant, and circulates in succession in the first heat exchanger where it gives up heat to the heat-transfer fluid, in the expansion device where it becomes low-pressure refrigerant, in the second heat exchanger where it receives heat from the heat-transfer fluid, and returns to the compressor,
a first heat-transfer fluid flow circulates in succession in the primary loop, in the first pump, in the first heat exchanger where it receives heat from the refrigerant, in the primary loop, in the first bypass branch, in the fourth bypass branch, in the sixth heat exchanger where it gives up heat to the outside air stream, in the second bypass branch, and returns to the first pump,
a second heat-transfer fluid flow circulates in the secondary loop, in the third pump, in the second heat exchanger where it gives up heat to the refrigerant, circulates in the secondary loop, and splits at the seventh connection point into:
   a third heat-transfer fluid flow which circulates in the third bypass branch, in the fifth heat exchanger where it receives heat from the inside air stream, and joins the fifth connection point,
   a fourth heat-transfer fluid flow which circulates in the secondary loop between the sixth connection point and the ninth connection point, and splits at the ninth connection point into:
      a fifth heat-transfer fluid flow circulating in the secondary loop, in succession in the second pump, in the fourth heat exchanger, and
      a sixth heat-transfer fluid flow circulating in the fifth bypass branch, in the seventh heat exchanger,
      the fifth heat-transfer fluid flow and the sixth heat-transfer fluid flow merging at the tenth connection point,
   the fourth heat-transfer fluid flow thus formed circulating between the tenth connection point and the fifth connection point,
   the fourth heat-transfer fluid flow joining the third heat-transfer fluid flow at the fifth
and the second heat-transfer fluid flow thus formed returns to the third pump.

The invention also relates to a method for operation of a thermal conditioning system as described above, in a so-called passenger compartment heating mode, in which:
a refrigerant flow circulates in the compressor where it becomes high-pressure refrigerant, and circulates in succession in the first heat exchanger where it gives up heat to the heat-transfer fluid, in the expansion device where it becomes low-pressure refrigerant, in the second heat exchanger where it receives heat from the heat-transfer fluid, and returns to the compressor,
a first heat-transfer fluid flow circulates in succession in the first pump, in the first heat exchanger where it receives heat from the refrigerant, in the third heat exchanger where it gives up heat to the inside air stream, and returns to the first pump,
a second heat-transfer fluid flow circulates in the secondary loop, in the third pump, in the second heat exchanger where it gives up heat to the refrigerant, and splits at the second connection point into:
   a third heat-transfer fluid flow which circulates in the secondary loop and splits at the ninth connection point into:
      a fourth heat-transfer fluid flow circulating in the secondary loop, in succession in the second pump, in the fourth heat exchanger, and
      a fifth heat-transfer fluid flow circulating in the fifth bypass branch, in the seventh heat exchanger,
      the fourth heat-transfer fluid flow and the fifth heat-transfer fluid flow merging at the tenth connection point,
   the third heat-transfer fluid flow thus formed joining the fourth connection point,
   a sixth heat-transfer fluid flow which circulates in succession in the first bypass branch, in the fourth bypass branch, in the sixth heat exchanger where it receives heat from the outside air stream, in the second bypass branch, and joins the fourth
   the third heat-transfer fluid flow and the sixth heat-transfer fluid flow merging at the fourth connection point,
and the second heat-transfer fluid flow thus formed returns to the third pump.

The invention also relates to a method for operation of a thermal conditioning system as previously described, in a so-called passenger compartment heating and dehumidification mode, in which:
a refrigerant flow circulates in the compressor where it becomes high-pressure refrigerant, and circulates in succession in the first heat exchanger where it gives up heat to the heat-transfer fluid, in the expansion device where it becomes low-pressure refrigerant, in the second heat exchanger where it receives heat from the heat-transfer fluid, and returns to the compressor,
a first heat-transfer fluid flow circulates in succession in the first pump, in the first heat exchanger where it receives heat from the refrigerant, in the third heat exchanger where it gives up heat to the inside air stream, and returns to the first pump,
a second heat-transfer fluid flow circulates in the secondary loop, in the third pump, in the second heat exchanger where it gives up heat to the refrigerant, and splits at the sixth connection point into:
   a third heat-transfer fluid flow which circulates in the third bypass branch, in the fifth heat exchanger where it receives heat from the inside air stream, and joins the fifth connection point,
   a fourth heat-transfer fluid flow which circulates in the secondary loop, and splits at the second connection point into:
      a fifth heat-transfer fluid flow which circulates in the secondary loop between the second connection point and the ninth connection point, and splits into:
         a sixth heat-transfer fluid flow circulating in the secondary loop, in succession in the second pump, in the fourth heat exchanger, and
         a seventh heat-transfer fluid flow circulating in the fifth bypass branch, in the
         the sixth heat-transfer fluid flow and the seventh heat-transfer fluid flow merging at the tenth connection point,
      the fifth heat-transfer fluid flow thus formed joining the fifth connection point,
      the fifth heat-transfer fluid flow joining the third heat-transfer fluid flow at the fifth connection point,
      the eighth flow thus formed joining the fourth connection point,
   a ninth heat-transfer fluid flow which circulates in succession in the first bypass branch, in the fourth bypass branch, in the sixth heat exchanger where it receives heat from the outside air stream, in the second bypass branch, and joins the fourth connection point,
   the eighth heat-transfer fluid flow and the ninth heat-transfer fluid flow merging at the fourth connection point,
and the second heat-transfer fluid flow thus formed returns to the third pump.

The invention also relates to a method of operation of a thermal conditioning system as described above, comprising the fifth pump, in a so-called mode of cooling of the electronic control unit of the electric motor and/or of the electric motor itself by the sixth heat exchanger, in which:
a heat-transfer fluid flow circulates in succession in the fifth pump, in the fifth bypass branch, in the seventh heat exchanger, in the fifth bypass branch, in the secondary loop, in the second bypass branch, in the fourth bypass branch, in the sixth heat exchanger where it gives up heat to the outside air stream, in the fourth bypass branch, in the first bypass branch, in the secondary loop, in the fifth bypass branch, and returns to the fifth pump.

The invention also relates to a method of operation of a thermal conditioning system as described above, comprising the fifth pump, in a so-called mode of heating of the battery by the electronic control unit of the electric motor and/or the electric motor itself, in which:
a heat-transfer fluid flow circulates in succession in the fifth pump, in the fifth bypass branch, in the seventh heat exchanger, in the fifth bypass branch, in the secondary loop, in the fourth heat exchanger where it gives up heat to the first element of the electric drive train of the vehicle, in the secondary loop, in the fifth bypass branch, and returns to the fifth pump.

### BRIEF DESCRIPTION OF THE DRAWINGS

Further features, details and advantages will become apparent on reading the detailed description below, and on studying the attached drawings, in which:

FIG. 1 is a schematic view of a thermal conditioning system according to one embodiment of the invention,

FIG. 2 is a schematic view of a thermal conditioning system according to a first variant of the embodiment from FIG. 1,

FIG. 3 is a schematic view of a thermal conditioning system according to a second variant of the embodiment from FIG. 1,

FIG. 4 is a schematic view of a thermal conditioning system according to a third variant of the embodiment from FIG. 1,

FIG. 5 is a schematic view of a thermal conditioning system according to a fourth variant of the embodiment from FIG. 1,

FIG. 6 is a schematic view of a thermal conditioning system according to a fifth variant of the embodiment from FIG. 1,

FIG. 7 is a schematic view of a thermal conditioning system according to a sixth variant of the embodiment from FIG. 1,

FIG. 8 shows a schematic view of the thermal conditioning system from FIG. 1 according to a first operating mode, known as drive train and passenger compartment cooling mode,

FIG. 9 shows a schematic view of the thermal conditioning system from FIG. 1 according to a second operating mode, known as passenger compartment heating mode,

FIG. 10 shows a schematic view of the thermal conditioning system from FIG. 1 according to a third operating mode, known as passenger compartment heating and dehumidification mode,

FIG. 11 is a schematic view of a thermal conditioning system according to a seventh variant of the embodiment from FIG. 1,

FIG. 12 shows a schematic view of the thermal conditioning system from FIG. 11 according to a fourth operating mode, known as cooling of the electronic control unit of the electric motor and/or of the electric motor itself by the sixth heat exchanger,

FIG. 13 shows a schematic view of the thermal conditioning system from FIG. 11 according to a fifth operating mode, known as heating of the battery by the electronic control unit of the electric motor and/or the electric motor itself.

### DESCRIPTION OF THE EMBODIMENTS

To make the figures easier to read, the various elements are not necessarily shown to scale. In these figures, identical elements bear the same reference signs. Certain elements or parameters may be indexed, that is to say designated for example as the first element or the second element, or indeed the first parameter and the second parameter, etc. The aim of this indexing is to differentiate between elements or parameters which are similar but not identical. This ordinal numbering does not imply any priority of one element, or parameter, over another. The terms ‘first’, ‘second’, ‘third’, etc. can thus be interchanged.

In the description that follows, the expression “a first element upstream of a second element” means that the first element is placed before the second element with respect to the direction of circulation, or travel, of a fluid. Similarly, the expression “a first element downstream of a second element” means that the first element comes after the second element with respect to the direction of circulation, or flow, of the fluid in question. In the case of the refrigerant fluid circuit, the expression “a first element is upstream of a second element” means that the refrigerant fluid travels successively through the first element and then the second element, without passing via the compression device. In other words, the refrigerant leaves the compression device, optionally passes through one or more elements, and then passes through the first element, then the second element, then returns to the compression device, optionally having passed through further elements.

The expression “a second element is placed between a first element and a third element” means that the shortest path for traveling from the first element to the third element passes via the second element.

When it is specified that a sub-system has a given element, this does not rule out the presence of other elements in this sub-system.

Within the meaning of the present disclosure, the term “exchanger” is equivalent to the term “heat exchanger”. Likewise, the term “expansion valve” is equivalent to the term “expansion device”, and the term “compressor” is equivalent to the term “compression device”.

Each of the expansion devices used can be an electronic expansion device, a thermostatic expansion device, or a calibrated orifice. In the case of an electronic expansion device, the flow cross-section allowing passage of the refrigerant can be adjusted continuously between a closed position and a fully open position. To this end, an electronic control module controls an electric motor which moves a movable shut-off device controlling the flow cross-section available to the refrigerant.

The thermal conditioning system 100 that will be described may be fitted to a motor vehicle. The motor vehicle is electric or hybrid.

An electronic control unit, not shown, receives information from various sensors measuring in particular the characteristics of the refrigerant. The electronic control unit also receives setpoints issued by the occupants of the vehicle, such as the desired temperature in the interior of the passenger compartment. The electronic control unit implements control laws for operating the various actuators, in order to control the thermal conditioning system 100 so as to achieve the setpoints received. A compression device 15 makes it possible to cause a coolant to circulate in a closed coolant circulation circuit 10. The compression device 15 may be an electric compressor, i.e. a compressor, the movable parts of which are driven by an electric motor. The compression device 15 comprises a side for aspiration of the coolant fluid at low pressure, also known as the inlet 15a of the compression device, and a side for delivery of the coolant fluid at high pressure, also known as the outlet 15b of the compression device 15. The internal moving parts of the compressor 15 take the coolant from low pressure on the inlet 15a side to high pressure on the outlet 15b side. After expansion in one or more expansion members, the refrigerant returns to the inlet 15a of the compressor 15 and begins a new thermodynamic cycle.

The refrigerant fluid used by the refrigerant fluid circuit 10 is in this case a chemical fluid such as R1234yf. Other refrigerants could be used, such as R134a, R744 or R290 for example.

The thermal conditioning system 100 comprises a heat-transfer fluid circuit 20 in which a heat-transfer fluid can circulate under the action of one or more pumps. The circuit comprises various circulation loops connected by various bypass branches. Each connection point between two circuit portions allows the heat-transfer fluid to pass into one or the other of the circuit portions that meet at this connection point. In other words, each connection point is a means for redirecting the heat-transfer fluid arriving at this connection point.

The heat-transfer fluid used by the heat-transfer fluid circuit 20 may be water, a mixture of water and ethylene glycol, or a dielectric heat-transfer fluid.

An inside air stream Fi is understood to mean an air stream intended for the passenger compartment of the motor vehicle. This inside air stream can circulate in a heating, ventilation and air conditioning (HVAC) installation. This installation has not been shown in the various figures.

An outside air stream Fe is understood to mean an air stream that is not intended for the passenger compartment of the vehicle. In other words, this air stream remains outside the passenger compartment.

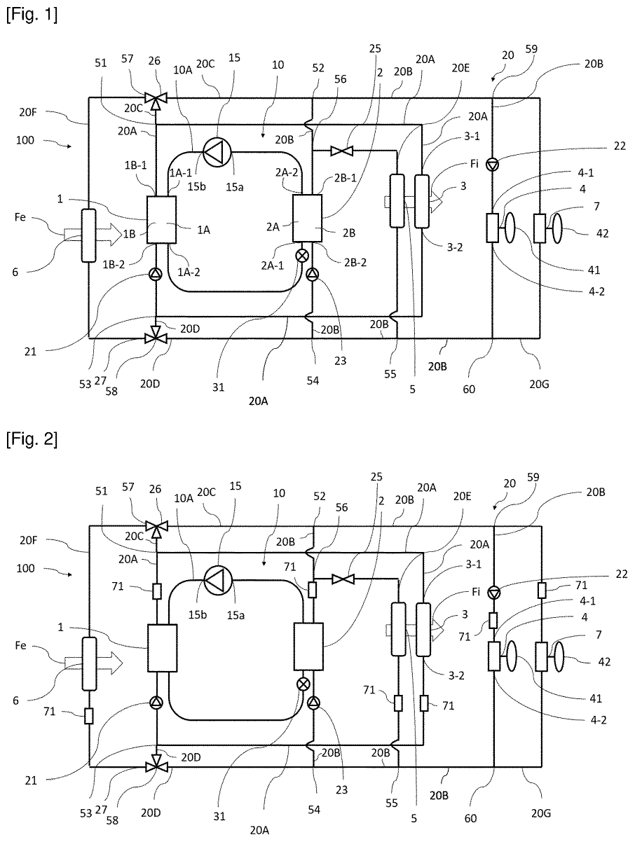

FIG. 1 shows a thermal conditioning system 100 for a motor vehicle.

The thermal conditioning system 100 comprises:
a heat-transfer fluid circuit 20, in particular for dielectric heat-transfer fluid, comprising:
   a primary heat-transfer fluid circulation loop 20A,
   a secondary heat-transfer fluid circulation loop 20B,
a refrigerant circuit 10 comprising a main refrigerant circulation loop 10A, the main loop 10A comprising in succession, in a direction of circulation of the refrigerant:
   a compression device 15,
   a first heat exchanger 1, arranged both on the main refrigerant loop 10A and on the primary heat-transfer fluid loop 20A, so as to allow a heat exchange between the refrigerant and the heat-transfer fluid,
   an expansion device 31,
   a second heat exchanger 2, arranged both on the main refrigerant loop 10A and on the secondary heat-transfer fluid loop 20B, so as to allow a heat exchange between the refrigerant and the heat-transfer fluid,
      wherein:
the primary heat-transfer fluid loop 20A comprises a third heat exchanger 3 configured to exchange heat with an air stream Fi inside a passenger compartment of the vehicle, and
the secondary heat-transfer fluid loop 20B comprises a fourth heat exchanger 4 configured to be thermally coupled to a first element 41 of an electric drive train of the vehicle,
   wherein the heat-transfer fluid circuit 20 comprises:
a first bypass branch 20C connecting a first connection point 51, positioned on the primary loop 20A between a first outlet 1B-1 of the first heat exchanger 1 and a first inlet 3-1 of the third heat exchanger 3, to a second connection point 52, positioned on the secondary loop 20B between a first outlet 2B-1 of the second heat exchanger 2 and a first inlet 4-1 of the fourth heat exchanger 4,
a second bypass branch 20D connecting a third connection point 53, positioned on the primary loop 20A between a second inlet 1B-2 of the first heat exchanger 1 and a second outlet 3-2 of the third heat exchanger 3, to a fourth connection point 54, positioned on the secondary loop 20B between a second inlet 2B-2 of the second heat exchanger 2 and a second outlet 4-2 of the fourth heat exchanger 4, and wherein:
the heat-transfer fluid circuit 20 comprises a third bypass branch 20E connecting a fifth connection point 55, positioned on the secondary loop 20B between the second outlet 4-2 of the fourth heat exchanger 4 and the fourth connection point 54, to a sixth connection point 56 positioned on the secondary loop 20B, between the first outlet 2B-1 of the second heat exchanger 2 and the first inlet 4-1 of the fourth heat exchanger 4, the third bypass branch 20E comprising a fifth heat exchanger 5 configured to exchange heat with the air stream Fi inside the passenger compartment of the vehicle.

The refrigerant circuit 10 forms a closed circuit configured to cause circulation of the refrigerant. The heat-transfer fluid circuit 20 forms a circuit for circulation of heat-transfer fluid, i.e. a closed circuit configured to cause circulation of a heat-transfer fluid flow. In its nominal operating state, i.e. without any faults or anomalies, each of the circuits 10, 20 is sealed.

The primary loop 20A of the heat-transfer fluid circuit 20 forms a heat-transfer fluid circulation loop. Likewise, the secondary loop 20B of the heat-transfer fluid circuit 20 forms a heat-transfer fluid circulation loop. The primary loop 20A and the secondary loop 20B are connected by bypass branches. Each bypass branch comprises exactly one inlet and one outlet. Each bypass branch is connected at each of its ends to a portion of the heat-transfer fluid circuit. Each connection is formed at a connection point.

The refrigerant and the heat-transfer fluid can exchange heat in the first heat exchanger 1. The first heat exchanger 1 comprises a first heat exchange portion 1A through which the refrigerant travels, and a second heat exchange portion 1B through which the heat-transfer fluid travels. Heat is exchanged between the first heat exchange portion 1A and the second heat exchange portion 1B of the first heat exchanger 1.

Similarly, the refrigerant and the heat-transfer fluid can exchange heat in the second heat exchanger 2. The second heat exchanger 2 comprises a first heat exchange portion 2A through which the refrigerant travels, and a second heat exchange portion 2B through which the heat-transfer fluid travels. Heat is exchanged between the first heat exchange portion 2A and the second heat exchange portion 2B of the second heat exchanger 2.

The first heat exchanger 1 makes it possible to at least partially condense the high-temperature, high-pressure refrigerant leaving the compression device 15. The heat from condensation of the refrigerant fluid is thus transferred to the heat-transfer fluid of the heat-transfer fluid circuit 20. The heat-transfer fluid can thus be heated.

The second heat exchanger 2 can make it possible to at least partially evaporate the low-pressure refrigerant leaving the expansion device 31. The heat for evaporation of the refrigerant fluid is taken from the heat-transfer fluid. The heat-transfer fluid can thus be cooled.

The first heat exchanger 1 and the second heat exchanger 2 each respectively comprise a refrigerant inlet 1A-1, 2A-1 and a refrigerant outlet 1A-2, 2A-2. The first heat exchanger 1 and the second heat exchanger 2 each respectively comprise a heat-transfer fluid inlet 1B-2, 2B-2 and a heat-transfer fluid outlet 1B-1, 2B-1. Two different fluids travel through the first heat exchanger 1 and the second heat exchanger 2, each heat exchanger being a two-fluid heat exchanger.

The first element 41 of the electric drive train of the vehicle may be an electrical energy storage battery. The battery can supply the energy necessary for an electric drive motor of the vehicle. The thermal coupling with the fourth heat exchanger 4 may be achieved by means of a heat-transfer fluid circulation loop, not shown in the various figures. The thermal coupling may also be achieved by placing one or more walls of the fourth heat exchanger 4 in contact with one or more walls of the battery 41.

The fourth heat exchanger 4 can be formed by the battery itself, i.e. the battery dissipating heat is in direct contact with the heat-transfer fluid, when this is a dielectric heat-transfer fluid.

In particular, the electrical and/or electronic elements of the battery may be immersed, or partially immersed, in a dielectric heat-transfer fluid.

The third heat exchanger 3 is positioned in the heating, ventilation and air conditioning installation of the vehicle. The third heat exchanger 3 is a radiator for heating the passenger compartment.

A motor-fan unit, not shown, is positioned near the third heat exchanger 3 and can be activated in order to increase the flow of the inside air stream Fi if necessary.

The fifth heat exchanger 5 is positioned in the heating, ventilation and air conditioning installation of the vehicle. The fifth heat exchanger 5 is positioned upstream of the third heat exchanger 3 in the heating, ventilation and air conditioning installation of the vehicle. The fifth heat exchanger 5 is a radiator of the passenger compartment air conditioning system, and may also act as a dehumidifier.

According to the example illustrated, the sixth connection point 56 is positioned between the first outlet 2B-1 of the second heat exchanger 2 and the second connection point 52.

According to a variant (not shown), the sixth connection point 56 is positioned between the second connection point 52 and the first inlet 4-1 of the fourth heat exchanger 4.

The heat-transfer fluid circuit 20 comprises a fourth bypass branch 20F connecting a seventh connection point 57, positioned on the first bypass branch 20C, to an eighth connection point 58, positioned on the second bypass branch 20D, the fourth bypass branch 20F comprising a sixth heat exchanger 6.

The sixth heat exchanger 6 is configured to exchange heat with an air stream Fe outside the passenger compartment of the motor vehicle. The sixth heat exchanger 6 is for example positioned in the front face of the vehicle, behind the radiator grille. A second motor-fan unit (not shown) may be activated in order to increase the flow of the outside air stream Fe if necessary.

The seventh connection point 57 is positioned on the first bypass branch 20C between the first connection point 51 and the second connection point 52.

The eighth connection point 58 is positioned on the second bypass branch 20D between the third connection point 53 and the fourth connection point 54.

According to the example illustrated, the heat-transfer fluid circuit 20 of the thermal conditioning system 100 comprises a fifth bypass branch 20G positioned on the secondary loop 20B in parallel with the fourth heat exchanger 4, connecting a ninth connection point 59 positioned on the secondary loop 20B to a tenth connection point 60 positioned on the secondary loop 20B, the fifth bypass branch 20G comprising a seventh heat exchanger 7 configured to be thermally coupled to a second element 42 of the electric drive train of the vehicle.

The ninth connection point 59 is positioned on the secondary loop 20B between the second connection point 52 and the first inlet 4-1 of the fourth heat exchanger 4.

The tenth connection point 60 is positioned on the secondary loop 20B between the second outlet 4-2 of the fourth heat exchanger 4 and the fifth connection point 55.

The role of the seventh heat exchanger 7 is to thermally regulate the second element 42 of the electric drive train of the vehicle.

The second element 42 of the electric drive train of the vehicle may for example be an electronic control unit of an electric drive motor and/or an electric drive motor of the vehicle.

The seventh heat exchanger 7 may be formed by the actual electronic control unit of the electric motor, and/or by the electric motor itself, i.e. the electronic control unit of the electric motor and/or the electric motor dissipating heat are in direct contact with the heat-transfer fluid, when this is a dielectric heat-transfer fluid.

In particular, the electrical and/or electronic elements of the actual electronic control unit of the electric motor and/or the electric motor itself may be immersed, or partially immersed, in a dielectric heat-transfer fluid.

The primary loop 20A of the heat-transfer fluid comprises a first pump 21 configured to cause circulation of the heat-transfer fluid from the third connection point 53 towards the second inlet 1B-2 of the first heat exchanger 1.

According to the example illustrated, the first pump 21 is positioned between the third connection point 53 and the second inlet 1B-2 of the first heat exchanger 1.

According to a variant (not shown), the first pump 21 may be positioned between the first outlet 1B-1 of the first heat exchanger 1 and the first connection point 51.

The secondary loop 20B of the heat-transfer fluid comprises a second pump 22 configured to cause circulation of the heat-transfer fluid from the ninth connection point 59 towards the first inlet 4-1 of the fourth heat exchanger 4.

According to the example illustrated, the second pump 22 is positioned between the ninth connection point 59 and the first inlet 4-1 of the fourth heat exchanger 4.

According to a variant (not shown), the second pump 22 may be positioned between the second outlet 4-2 of the fourth heat exchanger 4 and the tenth connection point 60.

The first pump 21 and the second pump 22 are electrically controlled.

The heat-transfer fluid circuit 20 of the thermal conditioning system 100 comprises a first three-way valve 26 positioned both on the first bypass branch 20C and on the fourth bypass branch 20F.

The first three-way valve 26 is configured to selectively:
permit a circulation of heat-transfer fluid in the first bypass branch 20C, and prohibit a circulation of heat-transfer fluid between the first bypass branch 20C and the sixth heat exchanger 6, or
permit a circulation of heat-transfer fluid between the first bypass branch 20C and the sixth heat exchanger 6, and prohibit a circulation of heat-transfer fluid between the first bypass branch 20C and the primary heat-transfer fluid loop 20A, or
permit a circulation of heat-transfer fluid between the primary loop 20A and the sixth heat exchanger 6, and prohibit a circulation of heat-transfer fluid between the secondary loop 20B and the first bypass branch 20C.

The first three-way valve 26 makes it possible to selectively connect the sixth exchanger 6 either with the primary heat-transfer fluid circulation loop 20A or with the secondary loop 20B.

The seventh connection point 57 of the heat-transfer fluid circuit 20 forms part of the first three-way valve 26. Two of the three inlets/outlets of the first three-way valve 26 form part of the first bypass branch 20C and the last inlet/outlet forms part of the fourth bypass branch 20F.

The heat-transfer fluid circuit 20 comprises a second three-way valve 27 positioned both on the second bypass branch 20D and on the fourth bypass branch 20F.

The second three-way valve 27 is configured to selectively:
permit a circulation of heat-transfer fluid in the second bypass branch 20D, and prohibit a circulation of heat-transfer fluid between the second bypass branch 20D and the sixth heat exchanger 6, or
permit a circulation of heat-transfer fluid between the second bypass branch 20D and the sixth heat exchanger 6, and prohibit a circulation of heat-transfer fluid between the second bypass branch 20D and the primary heat-transfer fluid loop 20A, or
permit a circulation of heat-transfer fluid between the primary loop 20A and the sixth heat exchanger 6, and prohibit a circulation of heat-transfer fluid between the secondary loop 20B and the second bypass branch 20D.

The second three-way valve 27 makes it possible to selectively connect the sixth exchanger 6 either with the primary loop 20A or with the secondary loop 20B.

The eighth connection point 58 of the heat-transfer fluid circuit 20 forms part of the second three-way valve 27. Two of the three inlets/outlets of the first three-way valve 27 form part of the second bypass branch 20D and the last inlet/outlet forms part of the fourth bypass branch 20F.

The third bypass branch 20E comprises a shut-off valve 25 positioned between the fifth connection point 55 and the sixth connection point 56.

The shut-off valve 25 is a two-way valve.

The shut-off valve 25 is electrically controlled.

When the shut-off valve 25 is in the closed position, the circuit portion extending between the fifth connection point 55 and the sixth connection point 56, comprising the fifth heat exchanger 5, is isolated from the rest of the circuit.

According to the illustrated example, the shut-off valve 25 is positioned between the sixth connection point 56 and the fifth heat exchanger 5.

According to a variant (not shown), the shut-off valve 25 may be positioned between the fifth heat exchanger 5 and the fifth connection point 55.

The secondary loop 20B comprises a third pump 23 configured to cause the circulation of the heat-transfer fluid from the fourth connection point 54 towards the second inlet 2B-2 of the second heat exchanger 2.

The third pump 23 is electrically controlled.

According to the example illustrated, the third pump 23 is positioned between the fourth connection point 54 and the second inlet 2B-2 of the second heat exchanger 2.

According to a variant (not shown), the third pump 23 may be positioned between the first outlet 2B-1 of the second heat exchanger 2 and the sixth connection point 56.

FIG. 2 shows a thermal conditioning system 100 according to a first embodiment variant. In this first embodiment variant, at least the primary loop 20A and/or the secondary loop 20B comprises at least one filtering device 71, in particular at the outlet of the at least one of the pumps 21, 22 and/or the at least one of the heat exchangers 1, 2, 3, 4, 5, 6, 7.

The filtering devices 71 positioned on the at least one of the primary 20A and/or secondary loops 20B allow capture of debris, in particular metallic debris, in particular coming from the pumps 21, 22, 23 and/or the heat exchangers 1, 2, 3, 4, 5, 6, 7, which debris is liable to become detached during operation.

In particular, in the case of use of a heat-transfer fluid of the dielectric heat-transfer fluid type, and more particularly in the case where the fourth heat exchanger 4 and/or the seventh heat exchanger 7 are formed respectively by the battery and the actual electronic control unit of the electric motor and/or by the electric motor, the filtering devices 71 allow protection of the first and/or second elements 41, 42 of the electric drive train of the vehicle.

Preferably, the filtering devices 71 are positioned downstream of the first, second, third, fifth and/or sixth heat exchangers 1, 2, 3, 5, 6, and/or of the pumps 21, 22, 23, and/or upstream of the fourth and/or seventh heat exchangers 4, 7, the terms upstream and downstream being defined relative to the direction of circulation of the heat-transfer fluid.

In particular, in the case where the fourth heat exchanger 4 and the seventh heat exchanger 7 are formed respectively by the battery and the actual electronic control unit of the electric motor and/or by the electric motor itself, the filtering devices 71 are then preferably positioned in the battery and in the actual electronic control unit of the electric motor and/or in the electric motor itself, preferably at the inlet.

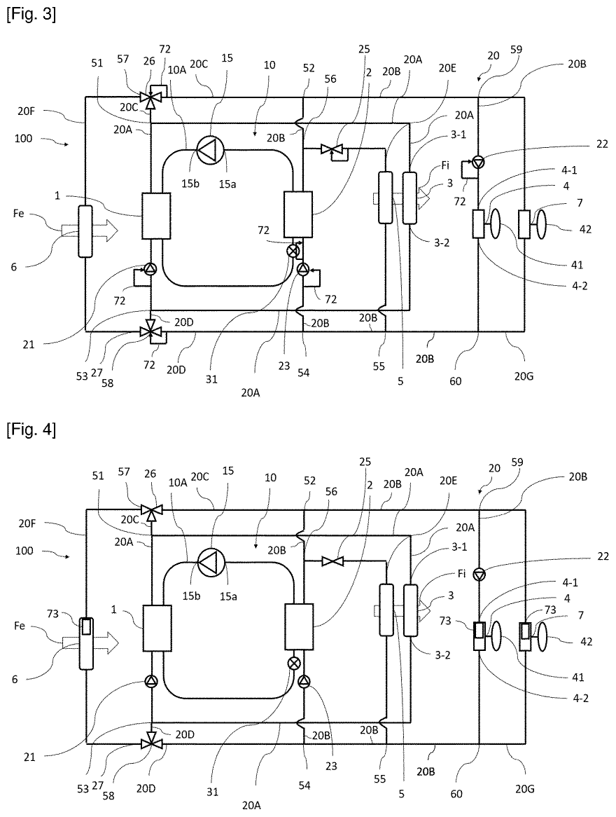

FIG. 3 shows a thermal conditioning system 100 according to a second embodiment variant. In this second embodiment variant, the heat-transfer fluid of the heat-transfer fluid circuit 20 is a dielectric heat-transfer fluid, and at least one of the pumps 21, 22, 23 and/or at least one of the three-way valves 26, 27 and/or the shut-off valve 25 and/or the expansion device 31 comprises a bypass circuit 72, connecting the heat-transfer fluid circuit 20 to the electronic power and control part of said at least one pump 21, 22, 23 and/or a three-way valve 26, 27 and/or the shut-off valve 25 and/or the expansion valve 31.

The bypass circuit 72 is a take-off branch fluidically connecting the heat-transfer fluid circuit 20 to the electronic power and control part of at least one component of the thermal conditioning system 100 amongst the pumps 21, 22, 23, the three-way valves 26, 27, the shut-off valve 25, and the expansion device 31. Said take-off branch is arranged as close as possible to said component.

By means of the bypass circuit 72, cooling of the electronic power and control part of the at least one pump 21, 22, 23 and/or three-way valve 26, 27 and/or shut-off valve 25 and/or expansion device 31 can be ensured.

The cooling of the electronic power and control part of the at least one pump 21, 22, 23 and/or three-way valve 26, 27 and/or shut-off valve 25 and/or expansion device 31 is achieved by circulation of the dielectric heat-transfer fluid in the compartment of the electronic power and control part.

FIG. 4 shows a thermal conditioning system 100 according to a third embodiment variant. In this third embodiment variant, the heat-transfer fluid of the heat-transfer fluid circuit 20 is a dielectric heat-transfer fluid, and at least one of the heat exchangers 1, 2, 3, 4, 5, 6, 7 comprises a desiccator 73.

The desiccator 73 is preferably positioned in the header tank of at least one of the heat exchangers 1, 2, 3, 4, 5, 6, 7.

The desiccators 73 enable moisture to be captured and can hence avoid the formation of mold.

The desiccators 73 can in particular take the form of receptacles containing silica gel, in particular in the form of crystals, or active charcoal, calcium sulphate, calcium chloride or molecular sieves, in particular zeolites.

In particular, in the case where the fourth heat exchanger 4 and the seventh heat exchanger 7 are formed respectively by the battery and the actual electronic control unit of the electric motor and/or by the electric motor itself, the desiccators 73 enable the removal of all traces of humidity from the dielectric heat-transfer fluid, and can hence avoid deterioration in its dielectric properties. Said desiccators 73 are then preferably positioned in the battery and in the actual electronic control unit of the electric motor and/or in the electric motor.

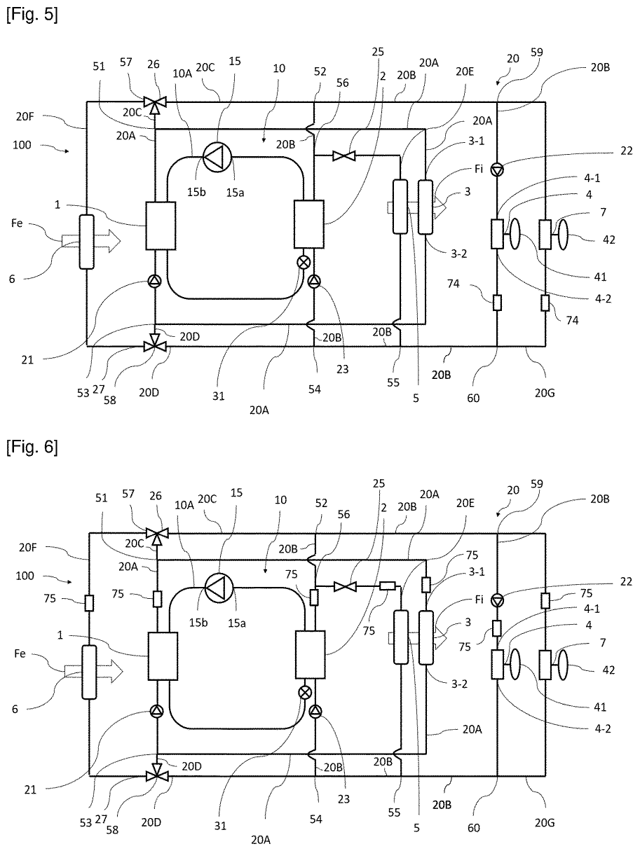

FIG. 5 shows a thermal conditioning system 100 according to a fourth embodiment variant. In this fourth embodiment variant, the heat-transfer fluid of the heat-transfer fluid circuit 20 is a dielectric heat-transfer fluid, and the secondary loop 20B and/or the fifth bypass branch 20G of the heat-transfer fluid circuit 20 comprises at least one sensor 74 configured to measure at least one parameter linked to the dielectric heat-transfer fluid, such as the electrical resistivity and/or the water content.

The at least one sensor 74 allows continuous monitoring of the electrical properties and the water content of the dielectric heat-transfer fluid.

In particular, the positioning of at least one sensor 74 on at least the secondary loop 20B and/or the fifth bypass branch 20G of the heat-transfer fluid circuit 20, more particularly upstream of the fourth heat exchanger 4 and/or the seventh heat exchanger 7, allows protection of the first and/or second elements 41, 42 of the electric drive train of the vehicle.

In particular, in the case where the fourth heat exchanger 4 and the seventh heat exchanger 7 are respectively formed by the battery and/or the actual electronic control unit of the electric motor and/or by the electric motor, the sensors 74 positioned upstream of the fourth and seventh heat exchangers 4, 7 make it possible to ensure that the electrical resistivity and water content in particular do not exceed certain values, and hence ensure the safety of the first and/or second elements 41, 42 of the electric drive train of the vehicle. Upstream is defined relative to the direction of circulation of the dielectric heat-transfer fluid.

In particular, in the case where the value of the electrical resistivity and/or water content exceeds a critical value, the circulation of the dielectric heat-transfer fluid could for example be interrupted by the stoppage of the pumps 21, 22, 23.

FIG. 6 shows a thermal conditioning system 100 according to a fifth embodiment variant. In this fifth embodiment variant, the heat-transfer fluid of the heat-transfer fluid circuit 20 is a dielectric heat-transfer fluid, and the heat-transfer fluid circuit 20 comprises at least one electrostatic discharge device 75 configured to discharge the electrostatic charge from the dielectric heat-transfer fluid.

The at least one electrostatic discharge device 75 allows discharge from the heat-transfer fluid of the electrostatic charge it has accumulated, for example by friction with the channels made of plastic.

According to a particular embodiment, the electrostatic discharge device 75 is formed by a metallic contact between a metallic part of at least one of the heat exchangers 1, 2, 3, 4, 5, 6, 7 and the structure of the vehicle.

In particular, in the case where the fourth heat exchanger 4 and/or the seventh heat exchanger 7 are formed respectively by the battery and the actual electronic control unit of the electric motor and/or by the electric motor, the electrostatic discharge devices 75 allow protection of the first and/or second elements 41, 42 of the electric drive train of the vehicle.

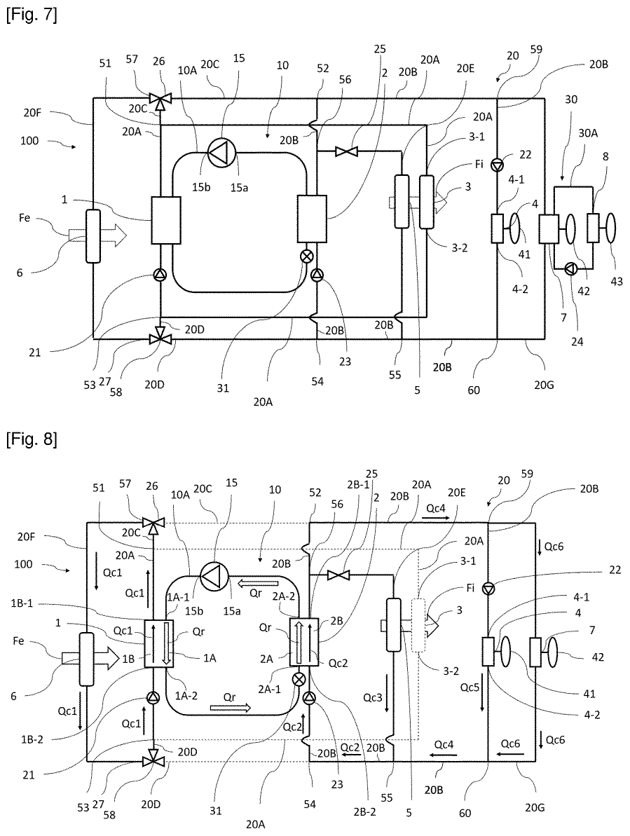

FIG. 7 shows a thermal conditioning system 100 according to a sixth embodiment variant. In this sixth embodiment variant, the thermal conditioning system 100 comprises a dielectric fluid circuit 30 comprising an additional loop 30A for circulation of dielectric fluid, the additional loop 30A comprising in succession, in a direction of circulation of the dielectric fluid:
an eighth heat exchanger 8 configured to be thermally coupled to a third element 43 of an electric drive train of the vehicle,
a fourth pump 24,
the seventh heat exchanger 7, arranged both on the secondary heat-transfer fluid loop 20B and on the additional dielectric fluid loop 30A, so as to allow heat exchange between the heat-transfer fluid and the dielectric fluid.

The role of the eighth heat exchanger 8 is to thermally regulate the third element 43 of the electric drive train of the vehicle.

The third element 43 of the electric drive train of the vehicle may for example be an electric drive motor of the vehicle.

The eighth heat exchanger 8 may be formed by the electric motor itself, i.e. the electric motor dissipating heat is in direct contact with the dielectric heat transfer fluid.

In particular, the electrical and/or electronic elements of the electric motor itself may be immersed, or partially immersed, in a dielectric fluid.

The dielectric fluid is a fluid which has a high viscosity and/or density, in particular higher than the viscosity and/or density of the heat-transfer fluid.

The dielectric fluid is in particular a fluid suitable for lubrication of the motor.

The dielectric fluid is in particular of the dielectric fluid or oil type.

According to a variant (not shown), the additional loop 30A of the dielectric fluid circuit 30 comprises at least one filtering device 71, in particular at the outlet of the fourth pump 24 and/or at the inlet of the eighth heat exchanger 8.

In the case where the eighth heat exchanger 8 is formed by the electric motor itself, the filtering device 71 is preferably arranged in the electric motor, preferably at the inlet.

According to a variant (not shown), at least the fourth pump 24 comprises a bypass circuit 72 connecting the dielectric fluid circuit 30 to the electronic power and control part of said at least fourth pump 24.

According to a variant (not shown), at least the eighth heat exchanger 8 comprises a desiccator 73.

The desiccator 73 is preferably positioned in the header tank of the eighth heat exchanger 8.

In the case where the eighth heat exchanger 8 is formed by the electric motor itself, the desiccator 73 is preferably arranged in the electric motor.

According to a variant (not shown), the additional loop 30A of the dielectric fluid circuit 30 comprises at least one sensor 74 configured to measure at least one parameter linked to the dielectric fluid, such as the electrical resistivity and/or the water content.

In particular, the positioning of at least one sensor 74 on the additional loop 30A of the dielectric fluid circuit 30, more particularly upstream of the eighth heat exchanger 8, allows protection of the third element 43 of the electric drive train of the vehicle.

According to a variant (not shown), the dielectric fluid circuit 30 comprises at least one electrostatic discharge device 75 configured to discharge the electrostatic charge from the dielectric fluid.

In particular, according to a variant (not shown), the electrostatic discharge device 75 is formed by a metallic contact between a metallic part of the eighth heat exchanger 8 and the structure of the vehicle.

According to one embodiment, at least one of the heat exchangers 1, 2, 3, 4, 5, 6, 7, 8 is liable to be obtained by a vacuum soldering process.

The vacuum soldering process of the heat exchangers 1, 2, 3, 4, 5, 6, 7, 8 allows protection of the heat-transfer fluid from contamination by the soldering flux, in particular in the case of use of a heat-transfer fluid of the dielectric heat-transfer fluid type.

A number of operating modes of the thermal conditioning system are possible. FIGS. 8 to 10 illustrate different methods of operation of a conditioning system as described above. In these figures, the portions of each of the circuits 10, 20 through which the fluid corresponding to this circuit travels are shown in solid thick lines, and the circuit portions through which no fluid travels are shown in dashed thin lines. In these figures, white arrows represent the direction of circulation of the refrigerant, and black arrows represent the direction of circulation of the heat transfer liquid.

FIG. 8 schematically illustrates a method of operation of a thermal conditioning system 100 as described above, in a so-called drive train and passenger compartment cooling mode, in which:
a refrigerant flow Qr circulates in the compressor 15 where it becomes high-pressure refrigerant, and circulates in succession in the first heat exchanger 1 where it gives up heat to the heat-transfer fluid, in the expansion device 31 where it becomes low-pressure refrigerant, in the second heat exchanger 2 where it receives heat from the heat-transfer fluid, and returns to the compressor 15,
a first heat-transfer fluid flow Qc1 circulates in succession in the primary loop 20A, in the first pump 21, in the first heat exchanger 1 where it receives heat from the refrigerant, in the primary loop 20A, in the first bypass branch 20C, in the fourth bypass branch 20F, in the sixth exchanger 6 where it gives up heat to the outside air stream Fe, in the second bypass branch 20D, and returns to the first pump 21,
a second heat-transfer fluid flow Qc2 circulates in the secondary loop 20B, in the third pump 23, in the second heat exchanger 2 where it gives up heat to the refrigerant, circulates in the secondary loop 20B, and splits at the sixth connection point 56 into:
   a third heat-transfer fluid flow Qc3 circulating in the third bypass branch 20E, in the fifth heat exchanger 5 where it receives heat from the inside air stream Fi, and joins the fifth connection point 55,
   a fourth heat-transfer fluid flow Qc4 which circulates in the secondary loop 20B between the sixth connection point 56 and the ninth connection point 59, and splits at the ninth connection point 59 into:
      a fifth heat-transfer fluid flow Qc5 circulating in the secondary loop 20B, in succession in the second pump 22, in the fourth heat exchanger 4, and
      a sixth heat-transfer fluid flow Qc6 circulating in the fifth bypass branch 20G, in the seventh heat exchanger 7,
      the fifth heat-transfer fluid flow Qc5 and the sixth heat-transfer fluid flow Qc6 merging at the tenth connection point 60,
   the fourth heat-transfer fluid flow Qc4 thus formed circulating between the tenth connection point 60 and the fifth connection point 55,
   the fourth heat-transfer fluid flow Qc4 joining the third heat-transfer fluid flow Qc3 at the fifth connection point 55,
and the second heat-transfer fluid flow Qc2 thus formed returns to the third pump 23.

In this operating mode, the inside air stream Fi is cooled in the fifth heat exchanger 5. The heat dissipated by the elements of the electric drive train, in the fourth exchanger 4 and the seventh exchanger 7, is transferred to the refrigerant in the second exchanger 2. The elements of the drive train are thus cooled.

The heat received by the heat-transfer fluid in the first heat exchanger 1 is dissipated into the outside air stream Fe in the sixth heat exchanger 6.

The heat-transfer fluid does not circulate in the third heat exchanger 3, which does not therefore heat the inside air stream Fi. Since the shut-off valve 25 is open, the fifth heat exchanger 5 cools the inside air stream Fi.

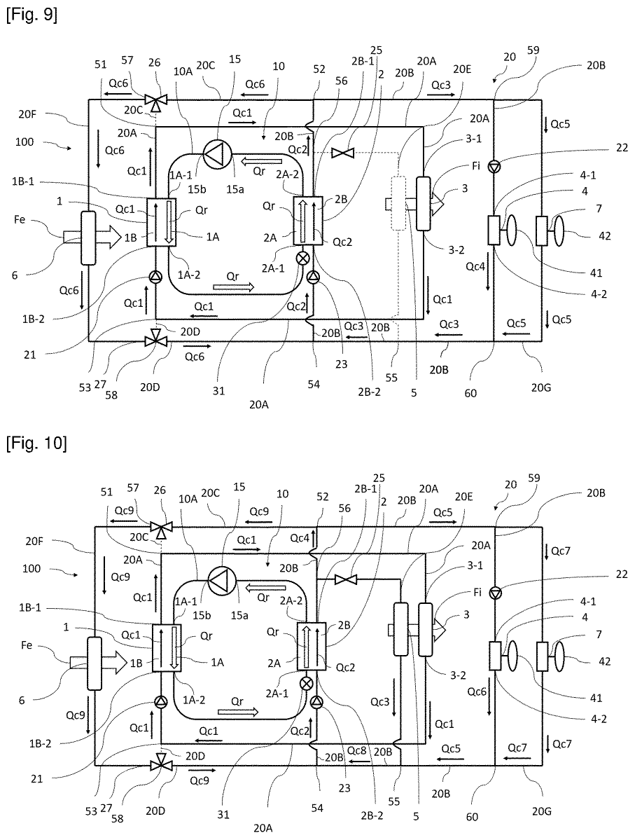

FIG. 9 illustrates a method for operation of a thermal conditioning system 100 as described above, in a so-called passenger compartment heating mode, in which:
a refrigerant flow Qr circulates in the compressor 15 where it becomes high-pressure refrigerant, and circulates in succession in the first heat exchanger 1 where it gives up heat to the heat-transfer fluid, in the expansion device 31 where it becomes low-pressure refrigerant, in the second heat exchanger 2 where it receives heat from the heat-transfer fluid, and returns to the compressor 15,
a first heat-transfer fluid flow Qc1 circulates in succession in the first pump 21, in the first heat exchanger 1 where it receives heat from the refrigerant, in the third heat exchanger 3 where it gives up heat to the inside air stream Fi, and returns to the first pump 21,
a second heat-transfer fluid flow Qc2 circulates in the secondary loop 20B, in the third pump 23, and in the second heat exchanger 2 where it gives up heat to the refrigerant, and splits at the second connection point 52 into:
   a third heat-transfer fluid flow Qc3 which circulates in the secondary loop 20B, and splits at the ninth connection point 59 into:
   a fourth heat-transfer fluid flow Qc4 circulating in the secondary loop 20B, in succession in the second pump 22, in the fourth heat exchanger 4, and
      a fifth heat-transfer fluid flow Qc5 circulating in the fifth bypass branch 20G, in the seventh heat exchanger 7,
      the fourth heat-transfer fluid flow Qc4 and the fifth heat-transfer fluid flow Qc5 merging at the tenth connection point 60,
   the third heat-transfer fluid flow Qc3 thus formed joining the fourth connection point 54,
   a sixth heat-transfer fluid flow Qc6 which circulates in succession in the first bypass branch 20C, in the fourth bypass branch 20F, in the sixth heat exchanger 6 where it receives heat from the outside air stream Fe, in the second bypass branch 20D, and joins the fourth connection point 54,
   the third heat-transfer fluid flow Qc3 and the sixth heat-transfer fluid flow Qc6 merging at the fourth connection point 54,
and the second heat-transfer fluid flow Qc2 thus formed returns to the third pump 23.

The inside air stream Fi is heated in the third heat exchanger 3.

The heat dissipated into the elements of the electric drive train is transferred to the heat transfer liquid in the fourth heat exchanger 4 and the seventh heat exchanger 7. This heat is transferred to the refrigerant in the second heat exchanger 2.

In addition, the heat-transfer fluid can receive heat from the outside air stream Fe in the sixth heat exchanger 6. The passenger compartment is thus heated by recovering energy both from the drive train and from the outside air stream Fe, i.e. by performing a dual energy recovery.

The primary loop 20A and the secondary loop 20B of heat-transfer fluid are not connected. The first three-way valve 26 prevents the circulation of heat-transfer fluid between the first connection point 51 and the seventh connection point 57. The second three-way valve 27 prevents the circulation of heat-transfer fluid between the eighth connection point 58 and the third connection point 53. The shut-off valve 25 is in the closed position, and the fifth heat exchanger 5 is inactive.

FIG. 10 illustrates a method for operating a thermal conditioning system 100 as described above, in a so-called passenger compartment heating and dehumidifying mode, in which:
a refrigerant flow Qr circulates in the compressor 15 where it becomes high-pressure refrigerant, and circulates in succession in the first heat exchanger 1 where it gives up heat to the heat-transfer fluid, in the expansion device 31 where it becomes low-pressure refrigerant, in the second heat exchanger 2 where it receives heat from the heat-transfer fluid, and returns to the compressor 15,
a first heat-transfer fluid flow Qc1 circulates in succession in the first pump 21, in the first heat exchanger 1 where it receives heat from the refrigerant, in the third heat exchanger 3 where it gives up heat to the inside air stream Fi, and returns to the first pump 21,
a second heat-transfer fluid flow Qc2 circulates in the secondary loop 20B, in the third pump 23, and in the second heat exchanger 2 where it gives up heat to the refrigerant, and splits at the sixth connection point 56 into:
   a third heat-transfer fluid flow Qc3 which circulates in the third bypass branch 20E, in the fifth heat exchanger 5 where it receives heat from the inside air stream Fi, and joins the fifth connection point 55,
      a fourth heat-transfer fluid flow Qc4 which circulates in the secondary loop 20B, and splits at the ninth connection point 52 into:
         a fifth heat-transfer fluid flow Qc5 which circulates in the secondary loop 20B between the second connection point 52 and the ninth connection point 59, and splits into:
         a sixth heat-transfer fluid flow Qc6 circulating in the secondary loop 20B, in succession in the second pump 22, in the fourth heat exchanger 4, and
         a seventh heat-transfer fluid flow Qc7 circulating in the fifth bypass branch 20G, in the seventh heat exchanger 7,
         the sixth heat-transfer fluid flow Qc6 and the seventh heat-transfer fluid flow Qc7 merging at the tenth connection point 60,
      the fifth heat-transfer fluid flow Qc5 thus formed joining the fifth connection point 55,
      the fifth heat-transfer fluid flow Qc5 joining the third heat-transfer fluid flow Qc3 at the fifth connection point 55,
   the eighth heat-transfer fluid flow Qc8 thus formed joining the fourth connection point 54,
   a ninth heat-transfer fluid flow Qc9 which circulates in succession in the first bypass branch 20C, in the fourth bypass branch 20F, in the sixth heat exchanger 6 where it receives heat from the outside air stream Fe, in the second bypass branch 20D, and joins the fourth connection point 54,
   the eighth heat-transfer fluid flow Qc8 and the ninth heat-transfer fluid flow Qc9 merging at the fourth connection point 54,
and the second heat-transfer fluid flow Qc2 thus formed returns to the third pump 23.

The shut-off valve 25 is in the open position, allowing the circulation of heat-transfer fluid in the fifth heat exchanger 5. The inside air stream Fi is cooled in the fifth heat exchanger 5 and is heated in the third heat exchanger 3. The inside air stream Fi is thus dehumidified. The amount of heat supplied by the third heat exchanger 3 is greater than the amount of heat absorbed by the fifth heat exchanger 5, and the air stream is thus heated.

The heat dissipated into the elements of the electric drive train is transferred to the heat transfer liquid in the fourth heat exchanger 4 and the seventh heat exchanger 7. This heat is transferred to the refrigerant in the second heat exchanger 2.

In addition, the heat-transfer fluid can receive heat from the outside air stream Fe in the sixth heat exchanger 6. The passenger compartment is thus heated by recovering energy both from the drive train and from the outside air stream Fe, i.e. by performing a dual energy recovery.

The primary loop 20A and the secondary loop 20B of heat-transfer fluid are not connected. The first three-way valve 26 prevents the circulation of heat-transfer fluid between the first connection point 51 and the seventh connection point 57. The second three-way valve 27 prevents the circulation of heat-transfer fluid between the eighth connection point 58 and the third connection point 53. The shut-off valve 25 is in the open position. In this operating mode, all of the heat exchangers are active and take part in the heat exchanges.

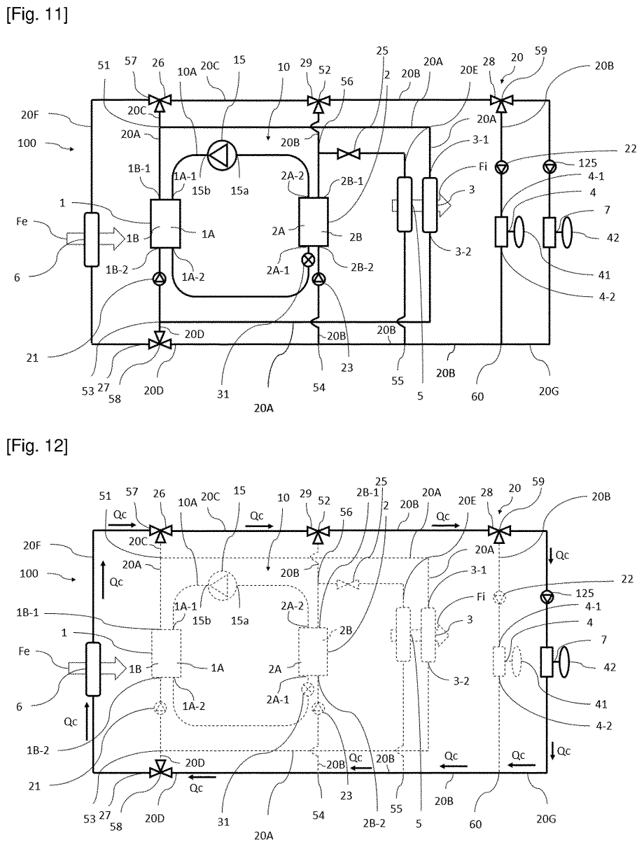

FIG. 11 shows a thermal conditioning system 100 according to a seventh variant embodiment. In this seventh variant embodiment, the heat-transfer fluid circuit 20 comprises a fifth circulation pump 125 positioned on the fifth bypass branch 20G.

The fifth pump 125 is configured to cause circulation of the heat-transfer fluid from the ninth connection point 59 towards the seventh heat exchanger 7.

According to the illustrated example, the fifth pump 125 is positioned between the ninth connection point 59 and the seventh heat exchanger 7.

According to a variant (not shown), the fifth pump 125 is positioned between the seventh heat exchanger 7 and the tenth connection point 60.

According to the illustrated example, the heat-transfer fluid circuit 20 comprises a third three-way valve 28 positioned both on the second bypass branch 20B and on the fifth bypass branch 20G.

The third three-way valve 28 is configured to selectively:
prohibit a circulation of heat-transfer fluid in the portion of the secondary loop 20B comprising the fourth heat exchanger 4, and permit a circulation of heat-transfer fluid between the rest of the secondary loop 20B and the fifth bypass branch 20G, or
permit a circulation of heat-transfer fluid between the portion of the secondary loop 20B comprising the fourth heat exchanger 4 and the fifth bypass branch 50G, and prohibit a circulation of heat-transfer fluid in the rest of the secondary loop 20B, or
permit a circulation of heat-transfer fluid between the secondary loop 20B and the fifth bypass branch 20G.

According to the illustrated example, the ninth connection point 59 of the heat-transfer fluid circuit 20 forms part of the third three-way valve 28. Two of the three inlets/outlets of the first three-way valve 28 form part of the secondary loop 20B and the last inlet/outlet forms part of the fifth bypass branch 20G.

According to the illustrated example, the heat-transfer fluid circuit 20 comprises a fourth three-way valve 29 positioned both on the second bypass branch 20B and on the first bypass branch 20C.

The fourth three-way valve 29 is configured to selectively:
prohibit a circulation of heat-transfer fluid in the portion of the secondary loop 20B comprising the second heat exchanger 2, and permit a circulation of heat-transfer fluid between the rest of the secondary loop 20B and the first bypass branch 20C, or
permit a circulation of heat-transfer fluid between the secondary loop 20B and the first bypass branch 20C.

According to the illustrated example, the second connection point 52 of the heat-transfer fluid circuit 20 forms part of the fourth three-way valve 29. Two of the three inlets/outlets of the fourth three-way valve 29 form part of the secondary loop 20B and the last inlet/outlet forms part of the first bypass branch 20C.

FIG. 12 schematically illustrates a method of operation of a thermal conditioning system 100 as described above, comprising the fifth pump 125, in a so-called mode of cooling of the electronic control unit of the electric motor and/or of the electric motor itself by the sixth heat exchanger, in which:
a heat-transfer fluid flow Qc circulates in succession in the fifth pump 125, in the fifth bypass branch 20G, in the seventh heat exchanger 7, in the fifth bypass branch 20G, in the secondary loop 20B, in the second bypass branch 20D, in the fourth bypass branch 20F, in the sixth heat exchanger 6 where it gives up heat to the outside air stream Fe, in the fourth bypass branch 20F, in the first bypass branch 20C, in the secondary loop 20B, in the fifth bypass branch 20G, and returns to the fifth pump 125.

The heat dissipated into the second element 42 of the electric drive train is transferred to the heat-transfer fluid in the seventh heat exchanger 7. This heat is transferred to the outside air stream Fe in the sixth heat exchanger 6.

The primary loop 20A and the secondary loop 20B of heat-transfer fluid are not connected. The first and second three-way valves 26 and 27 prevent the circulation of heat-transfer fluid between the seventh connection point 57 and the eighth connection point 58. The third three-way valve 28 prevents the circulation of heat-transfer fluid between the ninth connection point 59 and the tenth connection point 60. The fourth three-way valve 29 prevents the circulation of heat-transfer fluid between the second connection point 52 and the fourth connection point 54. The shut-off valve 25 is in the closed position. The compression device 15 is stopped, so the refrigerant fluid circuit 10 is inactive. The first, second, third, fourth and fifth heat exchangers 1, 2, 3, 4 and 5 are therefore inactive.

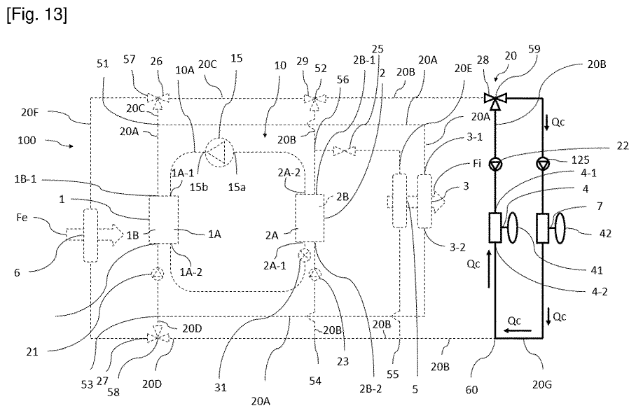

FIG. 13 schematically illustrates a method of operation of a thermal conditioning system 100 as described above, comprising the fifth pump 125, in a so-called mode of heating the battery by the electronic control unit of the electric motor and/or the electric motor itself, in which:
a heat-transfer fluid flow Qc circulates in succession in the fifth pump 125, in the fifth bypass branch 20G, in the seventh heat exchanger 7, in the fifth bypass branch 20G, in the secondary loop 20B, in the fourth heat exchanger 4 where it gives up heat to the first element 41 of the electric drive train of the vehicle, in the secondary loop 20B, in the fifth bypass branch 20G, and returns to the fifth pump 125. The heat dissipated into the second element 42 of the electric drive train is transferred to the heat-transfer fluid in the seventh heat exchanger 7. This heat is transferred to the outside air stream Fe in the sixth heat exchanger 6.

The heat dissipated into the second element 42 of the electric drive train is transferred to the heat-transfer fluid in the seventh heat exchanger 7. This heat is transferred to the first element 41 of the drive train in the fourth heat exchanger 4.

The third three-way valve 28 prevents the circulation of the heat-transfer fluid between the ninth connection point 59 and the second connection point 52, isolating the portion of the secondary loop 20B comprising the fourth heat exchanger 4 and the fifth bypass branch 20G comprising the seventh heat exchanger 7, from the rest of the heat-transfer fluid circuit 20. The second pump 22 is left free so as not to prevent the circulation of the heat-transfer fluid. The compression device 15 is stopped, so the refrigerant fluid circuit 10 is inactive. Only the fourth and seventh exchangers 4 and 7 are active.

Numerous other modes of operation, which are not shown, are also possible.

1. A thermal conditioning system for a motor vehicle, comprising:
a heat-transfer fluid circuit for dielectric heat-transfer fluid, comprising:
a primary heat-transfer fluid circulation loop,
a secondary heat-transfer fluid circulation loop,
a refrigerant circuit comprising a main refrigerant circulation loop, the main refrigerant circulation loop comprising in succession, in a direction of circulation of refrigerant:
a compression device,
a first heat exchanger, arranged both on the main refrigerant circulation loop and on the primary heat-transfer fluid loop, so as to allow a heat exchange between the refrigerant and the heat-transfer fluid,
an expansion device,
a second heat exchanger, arranged both on the main refrigerant circulation loop and on the secondary heat-transfer fluid loop, so as to allow a heat exchange between the refrigerant and the heat-transfer fluid,
wherein:
the primary heat-transfer fluid circulation loop comprises a third heat exchanger configured to exchange heat with an air stream inside a passenger compartment of the vehicle, and
the secondary heat-transfer fluid circulation loop comprises a fourth heat exchanger configured to be thermally coupled to a first element of an electric drive train of the vehicle,
wherein the heat-transfer fluid circuit comprises:
a first bypass branch connecting a first connection point, positioned on the primary heat-transfer fluid circulation loop between a first outlet of the first heat exchanger and a first inlet of the third heat exchanger, to a second connection point, positioned on the secondary heat-transfer fluid circulation loop between a first outlet of the second heat exchanger and a first inlet of the fourth heat exchanger,
a second bypass branch connecting a third connection point, positioned on the primary heat-transfer fluid circulation loop between a second inlet of the first heat exchanger and a second outlet of the third heat exchanger, to a fourth connection point, positioned on the secondary heat-transfer fluid circulation loop between a second inlet of the second heat exchanger and a second outlet of the fourth heat exchanger,
and wherein:
the heat-transfer fluid circuit comprises a third bypass branch connecting a fifth connection point, positioned on the secondary heat-transfer fluid circulation loop between the second outlet of the fourth heat exchanger and the fourth connection point, to a sixth connection point, positioned on the secondary heat-transfer fluid circulation loop between the first outlet of the second heat exchanger and the first inlet of the fourth heat exchanger, the third bypass branch comprising a fifth heat exchanger configured to exchange heat with the air stream inside the passenger compartment of the vehicle.

2. The thermal conditioning system as claimed in claim 1, wherein the heat-transfer fluid circuit comprises a fourth bypass branch connecting a seventh connection point, positioned on the first bypass branch to an eighth connection point, positioned on the second bypass branch, the fourth bypass branch comprising a sixth heat exchanger, wherein the sixth heat exchanger is configured to exchange heat with an air stream outside the passenger compartment of the vehicle.

3. The thermal conditioning system as claimed in claim 2, wherein the heat-transfer fluid circuit comprises a fifth bypass branch, positioned on the secondary heat-transfer fluid circulation loop in parallel with the fourth heat exchanger, connecting a ninth connection point positioned on the secondary heat-transfer fluid circulation loop to a tenth connection point positioned on the secondary heat-transfer fluid circulation loop the fifth bypass branch comprising a seventh heat exchanger configured to be thermally coupled to a second element of the electric drive train of the vehicle.

4. The thermal conditioning system as claimed in claim 3, wherein:
the primary heat-transfer fluid circulation loop of the heat-transfer fluid circuit comprises a first circulation pump,
the secondary heat-transfer fluid circulation loop of the heat-transfer fluid circuit comprises a second circulation pump.

5. The thermal conditioning system as claimed in claim 4, wherein the heat-transfer fluid circuit comprises:
a first three-way valve positioned both on the first bypass branch and on the fourth bypass branch,
a second three-way valve positioned both on the second bypass branch and on the fourth bypass branch,

6. The thermal conditioning system as claimed in claim, wherein the third bypass branch comprises a shut-off valve.

7. The thermal conditioning system as claimed in claim 4, wherein the secondary heat-transfer fluid circulation loop of the heat-transfer fluid circuit comprises a third circulation pump.

8. The thermal conditioning system as claimed in claim 6, wherein at least the primary heat-transfer fluid circulation loop and/or the secondary heat-transfer fluid circulation loop comprises at least one filtering device at the outlet of the at least one of the pumps and/or of the at least one of the heat exchangers.

9. The thermal conditioning system as claimed in claim 6, wherein the heat-transfer fluid of the heat-transfer fluid circuit is a dielectric heat-transfer fluid, and wherein at least one of the pumps and/or at least one of the three-way valves and/or the shut-off valve and/or the expansion device comprises a bypass circuit connecting the heat-transfer fluid circuit to an electronic power and control part of the at least one pump and/or a three-way valve and/or the shut-off valve and/or the expansion device.

10. The thermal conditioning system as claimed in claim 1, wherein the heat-transfer fluid of the heat-transfer fluid circuit is a dielectric heat-transfer fluid, and wherein at least one of the heat exchangers comprises a desiccator.

11. The thermal conditioning system as claimed in claim 3, wherein the heat-transfer fluid of the heat-transfer fluid circuit is a dielectric heat-transfer fluid, and wherein at least the secondary heat-transfer fluid circulation loop and/or the fifth bypass branch of the heat-transfer fluid circuit comprises at least one sensor configured to measure at least one parameter linked to the dielectric heat-transfer fluid, such as the electrical resistivity and/or the water content.

12. The thermal conditioning system as claimed in claim 1, wherein the heat-transfer fluid of the heat-transfer fluid circuit is a dielectric heat-transfer fluid, and wherein the heat-transfer fluid circuit comprises at least one electrostatic discharge device configured to discharge the electrostatic charge from the dielectric heat-transfer fluid.

13. The thermal conditioning system as claimed in claim 1, wherein the at least one of the heat exchangers is liable to be obtained by a vacuum soldering process.

14. The thermal conditioning system as claimed in claim 7, wherein the thermal conditioning system comprises a dielectric fluid circuit comprising an additional loop for circulation of dielectric fluid, the additional loop comprising in succession, in a direction of circulation of the dielectric fluid:
an eighth heat exchanger configured to be thermally coupled to a third element of an electric drive train of the vehicle,
a fourth circulation pump,
the seventh heat exchanger, arranged both on the secondary heat-transfer fluid circulation loop and on the additional loop, so as to allow a heat exchange between the heat-transfer and the dielectric fluid.
